(19) United States
(12) Patent Application Publication
(10) Pub. No.: US 2005/0241781 A1
(43) Pub. Date: Nov. 3, 2005

(54) Bi-fold door system

(76) Inventor: James A. Johnson, New Hope, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/116,570

(22) Filed: Apr. 28, 2005

Related U.S. Application Data
(60) Provisional application No. 60/566,062, filed on Apr. 28, 2004.

(51) Int. Cl. E05D 15/26

(52) U.S. Cl. 160/199

(57) ABSTRACT

A drive assembly for use with a bi-fold door is disclosed. The drive assembly includes a cylindrical housing, a shuttle disposed within the cylindrical housing, and a carriage supported about the cylindrical housing and operatively coupled to the shuttle. In this regard, the carriage is coupled to the bi-fold door, and wherein movement of the shuttle within the cylindrical housing moves the carriage along the cylindrical housing and moves the bi-fold door between open and closed positions.

### CROSS-REFERENCE TO RELATED APPLICATION

This application claims priority under 35 U.S.C. § 119(e) to U.S. Provisional Patent Application No. 60/566,062, filed Apr. 28, 2004, which is incorporated herein by reference.

### BACKGROUND

The present invention relates generally to powered or automated door systems, and more particularly to an automated bi-fold door system.

Automated doors have proven to be highly useful and particularly convenient in both residential and industrial settings. In particular, automated doors can be conveniently opened/closed by a remote activation of a powered mechanism connected to the automated doors. For example, even large automated doors can be opened by the simple push of a button. To this end, the powered mechanism mechanically moves the automated door between the opened/closed positions in response to a selected activation by an operator.

With the above in mind, the known automated door systems are typically electrically powered pneumatic or mechanical mechanisms. In this regard, a series of pulleys and/or multiple mechanical linkages are employed to activate the automated door between the opened/closed positions. Thus, the known automated door systems require a high level of maintenance. In addition, when the known automated doors are employed in windy and/or icy climates, the doors can fail to cycle open/close due to the force of the wind on the door panels, or due to icing of the linkages, or both.

Automated door systems have proven to be highly useful in a variety of residential and industrial applications. However, a need exists for a durable automated door system that has fewer parts to maintain.

### SUMMARY

One aspect of the present invention is related to a drive assembly for use with a bi-fold door. The drive assembly includes a cylindrical housing, a shuttle disposed within the cylindrical housing, and a carriage supported about the cylindrical housing and operatively coupled to the shuttle. In this regard, the carriage is coupled to the bi-fold door, and wherein movement of the shuttle within the cylindrical housing moves the carriage along the cylindrical housing and moves the bi-fold door between open and closed positions.

Another aspect of the present invention is related to a bi-fold door system. The bi-fold door system includes a bi-fold door including a driven panel and a jamb panel supported in an opening, a linear drive assembly supported about the opening and including a shuttle and a carriage operatively coupled to the shuttle, a jamb bracket assembly coupled to a door jamb of the opening and the jamb panel of the bi-fold door, and a drive bracket assembly coupled to the driven panel of the bi-fold door and coupled to the carriage of the linear drive assembly. In this regard, movement of the shuttle along a linear axis moves the carriage along the linear axis and moves the bi-fold door between open and closed positions.

Yet another aspect of the present invention is related to a method of opening and closing a bi-fold door supported in an opening. The method includes supporting a linear drive assembly about the opening and coupling a carriage of the linear drive assembly to a driven panel of the bi-fold door. The method additionally includes moving the carriage along a linear axis of the linear drive assembly, including moving the bi-fold door between open and closed positions.

Yet another aspect of the present invention is related to a bi-fold door system. The system includes a driven panel and a jamb panel supported within an opening, a linear drive assembly supported about the opening and including a carriage oriented along a linear axis, means for coupling the carriage to the driven panel of the bi-fold door, where a face of the driven panel is offset a first distance from the linear axis, and means for rotating the jamb panel of the bi-fold door about an axis offset a second distance from an edge of the jamb panel. In this regard, the first distance and the second distance are substantially equal.

### BRIEF DESCRIPTION OF THE DRAWINGS

FIG. 1 is a perspective view of a bi-fold door system illustrating a pair of bi-fold doors between a closed position and an open position according to one embodiment of the present invention.

FIG. 2 is a perspective view of a bi-fold door system illustrating a pair of bi-fold doors between a closed position and an open position according to one embodiment of the present invention.

FIG. 3 is a bottom view of a portion of the bi-fold door system shown in FIGS. 1 and 2.

FIG. 4 is a perspective view of the bi-fold door system shown in FIGS. 1 and 2 in the open position.

FIG. 5 is an enlarged partial view of the bi-fold door system of FIG. 4.

FIG. 6 is a top view of a portion of the bi-fold door system of FIG. 4.

FIGS. 7 and 8 are enlarged partial views of a left bi-fold door and a right bi-fold door, respectively, of the bi-fold door system shown in FIG. 4.

FIG. 9 is a perspective view of the bi-fold door system shown in FIGS. 1 and 2 in the closed position.

FIGS. 10-12 are enlarged partial views of the bi-fold door system shown in FIG. 9.

FIGS. 13 and 14 are top and bottom views, respectively, of the bi-fold door system shown in FIG. 9.

FIG. 15 is a partial view of the bi-fold door system in the closed position according to one embodiment of the present invention.

FIG. 16 is a side view of a portion of the bi-fold door system from the perspective of line 16-16 of FIG. 15.

FIG. 17 is a side view of a portion of the bi-fold door system from the perspective of line 17-17 of FIG. 15.

FIG. 18 is a perspective view of a jamb panel bracket for a bi-fold door system according to one embodiment of the present invention.

FIG. 19 is a perspective view of a door jamb bracket for a bi-fold door system according to one embodiment of the present invention.

FIG. 20 is a perspective view of a drive pin bracket for a bi-fold door system according to one embodiment of the present invention.

FIG. 21 is a perspective view of a driven panel bracket for a bi-fold door system according to one embodiment of the present invention.

FIG. 22 illustrates a bi-fold door system including a first break cylinder and a second break cylinder according to one embodiment of the present invention.

FIG. 23 is a simplified schematic of an air line routing path as coupled between a linear drive assembly and a pair of break cylinders according to one embodiment of the present invention.

### DETAILED DESCRIPTION

In the following detailed description, reference is made to the accompanying drawings that form a part hereof, and in which is shown by way of illustration specific embodiments in which the invention may be practiced. In this regard, directional terminology, such as “top,” “bottom,” “front,” “back,” “left,” “right,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

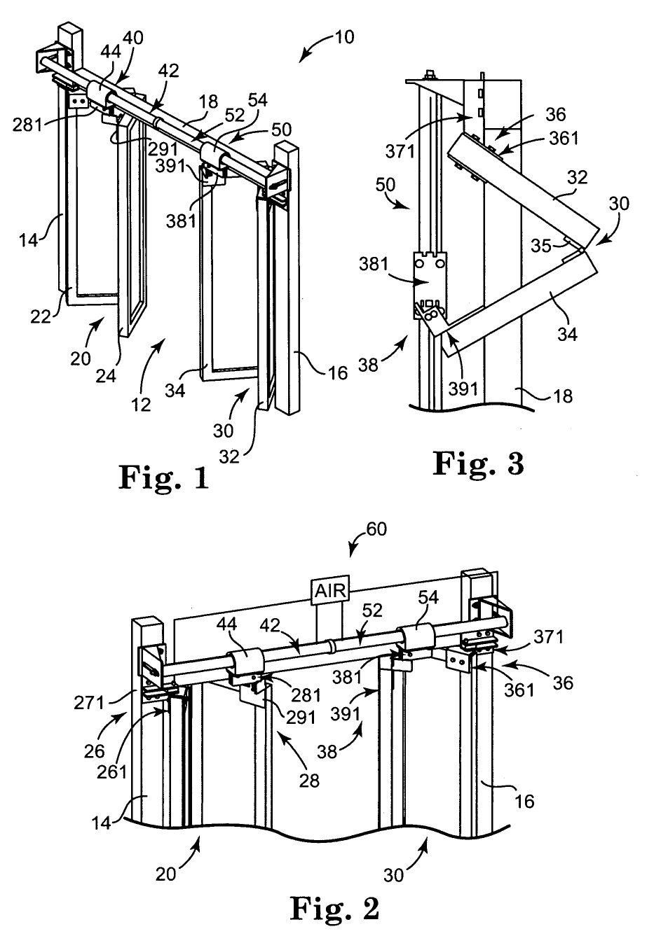

FIGS. 1-17 illustrate embodiments of a bi-fold door system 10 according to the present invention. With reference to FIG. 1, in one embodiment bi-fold door system 10 is configured and fitted for use within an opening 12 as defined by left and right door jambs 14 and 16, and header 18 (header 18 is also referred to as lintel 18). In one embodiment, bi-fold door system 10 includes a left door assembly 20, a right door assembly 30, a left drive assembly 40, and a right drive assembly 50. Left door assembly 20 and right door assembly 30 are positioned within opening 12 and moved between a closed position and an open position by left linear drive assembly 40 and right linear drive assembly 50, respectively, as described below.

FIGS. 1 and 2 illustrate one embodiment where left and right door assemblies 20 and 30 are each bi-fold door assemblies and include multiple hinged panels. As such, adjacent panels are hinged along adjacent edges or sides to permit pivoting of adjacent panels relative to each other. In one embodiment, left and right door assemblies 20 and 30 each include two hinged panels. More specifically, left door assembly 20 and right door assembly 30 each includes a respective jamb panel 22 and 32 and a respective driven panel 24 and 34. As such, jamb panels 22 and 32 are pivotally secured to the adjacent door jambs 14 and 16, respectively, and adjacent edges or sides of jamb panels 22 and 32, and respective driven panels 24 and 34, are pivotally connected.

FIG. 1 illustrates left and right door assemblies 20 and 30 positioned in opening 12 and forming a laterally symmetrical bi-fold door assembly having four folding panels comprising jamb panels 22 and 32 and center driven panels 24 and 34 centered within opening 12. In one embodiment, jamb panels 22 and 32 and driven panels 24 and 34 are each equal in size.

FIG. 3 illustrates one embodiment where the jamb panel 32 is connected to the driven panel 34 by flat folding hinges 35 that enable the panels 32, 34 to fold to a parallel state with respect to each other when the bi-fold door 30 is in a fully closed position, and a perpendicular state with respect to a plane of the opening when the bi-fold door 30 is in a fully open position. In one embodiment, when the bi-fold door 30 is opened, the jamb panel 32 swings about a pin attachment (not shown) connected to the adjacent door jamb 16 (FIG. 1) such that a jamb edge moves to the inside of the opening 12 (FIG. 1) within which the door assembly is installed. In addition, the adjacent edges of the jamb panels 22, 32 (FIG. 1) and the driven or center panels 24, 34 (FIG. 1) swing outwardly relative to the plane of the opening 12, due to the arrangement of the bracket assemblies, as described below.

With additional reference to FIG. 1, in one embodiment a linear drive assembly includes left and right drive assemblies 40 and 50 that each includes a linear drive mechanism. In one embodiment, the linear drive mechanisms move laterally and simultaneously in opposite directions while connected to pivotal brackets to open and close the bi-folding door.

FIG. 2 illustrates one embodiment where the linear drive assembly includes pneumatically operated magnetic drive assemblies. As such, left and right drive assemblies 40 and 50 each include a respective linear actuator 42 and 52, and a respective operator or carriage 44 and 54 supported for movement along the respective linear actuator 42, 52. In one embodiment, the linear drive assembly includes linear actuators 42 and 52 that each define a cylindrical housing, and a magnetic shuttle (not shown) positioned within a cylindrical housing, and carriages 44 and 54 coupled about the cylindrical housing and coupled to the shuttles. In one embodiment, carriages 44 and 54 are magnetic carriages magnetically coupled with a respective magnetic shuttle such that pneumatic movement of the shuttles within the cylindrical housing results in movement of the carriages 44, 54 along the cylindrical housings (and thus, movement of the bi-fold door assemblies 20, 30 to which the carriages 44, 54 are coupled).

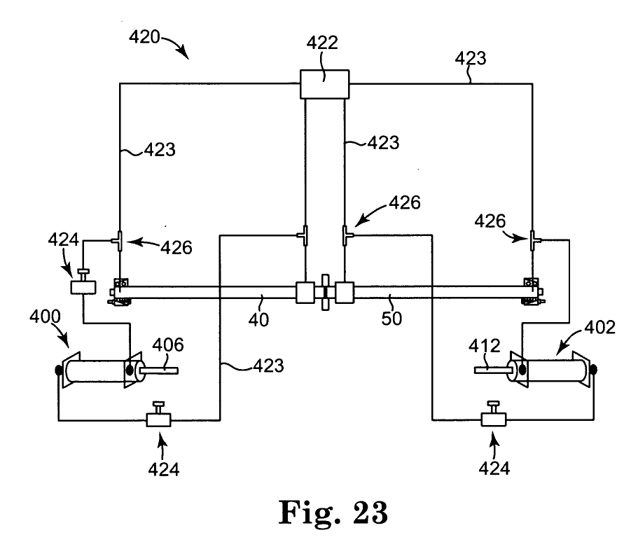

In addition, FIG. 2 illustrates one embodiment of an air pressure system 60 in communication with opposite ends of the cylindrical housings such that air pressure within the cylindrical housing is controlled to move the magnetic shuttles and, therefore, the magnetic carriages 44, 54, along the cylindrical housing. In this regard, in one embodiment, flow control valves (See FIG. 23) and air regulators are employed in selectively controlling air pressure delivered to the cylindrical housing. While the linear drive mechanism is illustrated and described as a pneumatically operated magnetic drive assembly, it is within the scope of the present invention for any automated drive means to be employed for the linear drive mechanisms such as, but not limited to, electric, air, screw drive, etc. drive means.

In one embodiment, as described below, jamb panels 22 and 32 of left and right door assemblies 20 and 30 (FIG. 1) are mounted within opening 12 by respective jamb bracket assemblies 26 and 36. In addition, driven panels 24 and 34 of left and right door assemblies 20 and 30 are coupled with left and right drive assemblies 40 and 50 by respective drive bracket assemblies 28 and 38.

Door jamb brackets 271, 371 are pinned and extend from the jamb panel brackets 261 and 361. While the jamb panel brackets 261 and 361 rotate with the door, the pins (not visible) allow the brackets to pivot with the folding motion of the door while simultaneously anchoring the door assemblies to the door jamb brackets 271, 371. Furthermore, at the same time, the drive bracket assemblies 28 and 38 rotate with the door while the drive pin brackets 281 and 381 move laterally along a longitudinal axis (i.e., a linear axis) of the linear drive assembly as the bi-fold door is open/closed.

FIG. 3 illustrates a bottom view of the right door panel assembly 30 in a partial open position. Linear drive pins (not visible) are positioned along a centerline of a longitudinal axis of the right linear drive assembly 50. The linear drive pins couple the drive bracket assembly 38 to the driven panel 34. Because of the perpendicular state of plates on the drive bracket assembly 38 in relation to the driven panel 34, when the bi-fold door opens, the plates rotate about the drive pins.

FIG. 3 provides a view of the drive mechanism 50 in relation to the partially opened panels 32, 34. As illustrated in FIG. 3, a driven panel bracket 391 is at a partially rotated state, yet remains perpendicular to the panel 34. Also, the pin (not visible) of the linear drive pin bracket 381 is still directly aligned with a center line of the drive mechanism 50 while the adjacent edges of the driven panel 34 and jamb panel 32 swing to the outside.

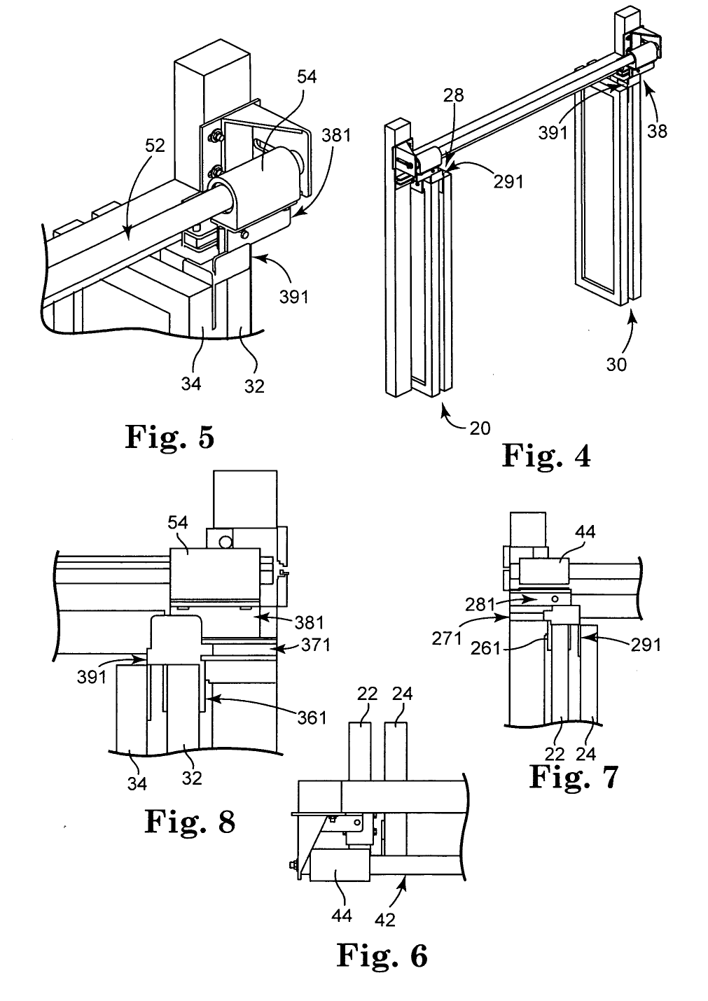

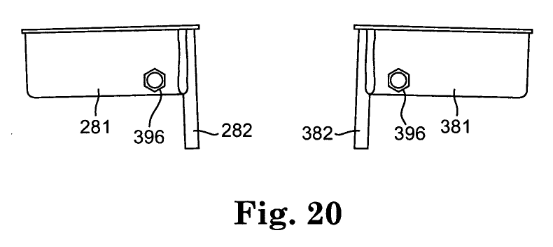

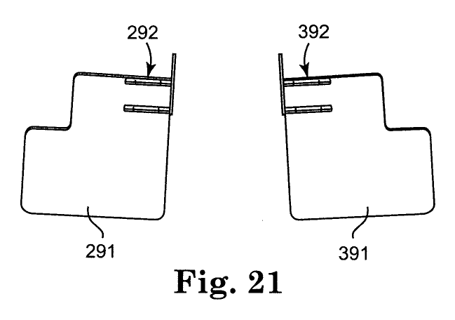

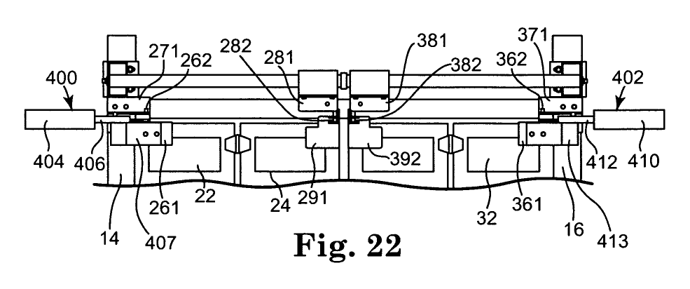

FIG. 4 is a general view of the bi-fold doors 20, 30 in a completely open position. The overlap of the drive bracket assemblies 28, 38 over their respective jamb bracket assemblies 26, 36 orient the drive panel parallel to the jamb panel. In one embodiment, a stabilizer bolt 396 is threadingly coupled to the drive pin bracket 281 and 381 (stabilizer bolt 396 is best illustrated in FIG. 20), orthogonal to the drive pins 282, 382, to stop and maintain the drive panels 24, 34 parallel to the jamb panels 22, 32.

FIG. 5 is a view of the right side of the bi-fold door 30 in the fully open position as viewed from the inside and illustrates how the drive pin bracket 381 rotates around the drive pin (not visible). As described above, the drive pin bracket 381 overlaps an edge of the jamb panel 32 when in the fully open position causing the plate of the drive pin bracket 381 to align parallel to a face of the drive panel bracket 391. As illustrated in FIG. 5, in the fully open position, the drive pin bracket 381 has rotated 90 degrees from its orientation in the closed position. Furthermore, stabilizer bolt 396 protrudes from the drive pin bracket 381 and acts as a stabilizer (or stop) for the drive pin bracket 381. In this position, the driven panel 34 and jamb panel 32 are stopped parallel with one another and are perpendicular to the jamb of the opening. In FIG. 5, it is to be understood that the stabilizer bolt 396 is generally encompassed by components of the bracketry and therefore not visible when viewing the bi-fold door.

FIG. 6 provides a general view of the top side of the left bi-fold door assembly 20. When fully open, the jamb panel 22 and driven panel 24 are oriented perpendicular to the longitudinal axis of the linear drive assembly 42.

FIG. 7 provides a general view of the left side of the bi-fold door assembly 20 as viewed from the inside. This view shows the relationship of the drive pin bracket 281 overlapping the jamb panel 22 in relationship to the jamb bracket assembly 26 (FIG. 2).

FIG. 8 provides a general view of the right side of the bi-fold door assembly 30 as viewed from the inside. As illustrated in FIG. 8, the driven panel 34 is parallel with the jamb panel 32. Also, the drive pin bracket 381 is overlapping the jamb panel 32. The drive pin bracket 381 covers the stabilizer bolt 396 (not visible) of the drive pin bracket 381, which is stopping the panels 32, 34 in a parallel orientation.

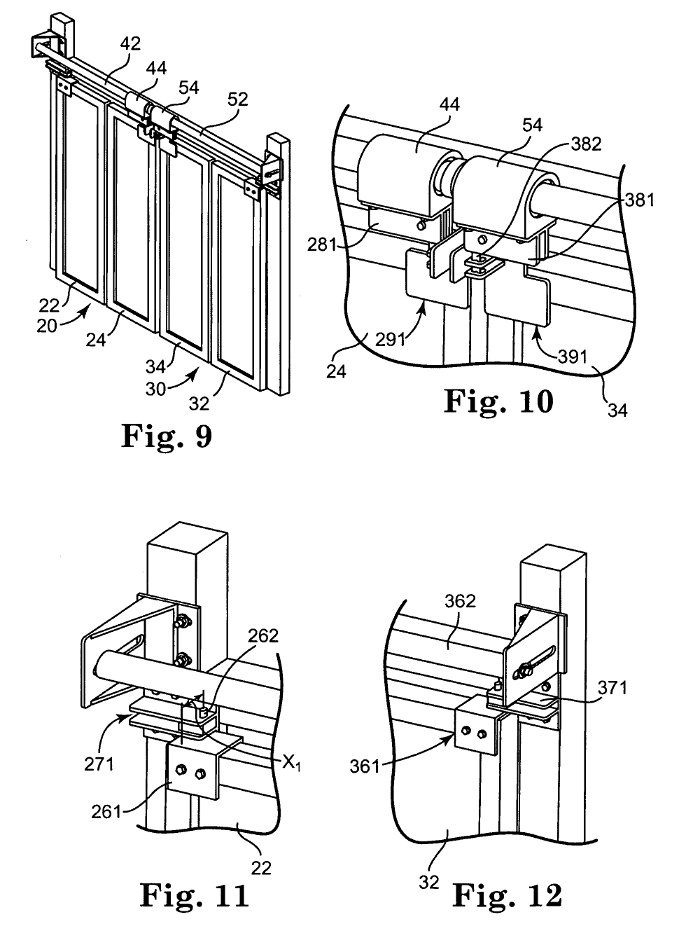

FIG. 9 through FIG. 12 illustrate a perspective view of the left door assembly 20 and the right door assembly 30. In this regard, FIG. 9 illustrates a relationship of the respective carriages 44, 54, FIGS. 11-12 illustrate a relationship of respective jamb panel brackets 261, 361 to door jamb brackets 271, 371, and FIG. 10 illustrates a relationship of respective drive pin brackets 281, 381 to drive panel brackets 291, 391.

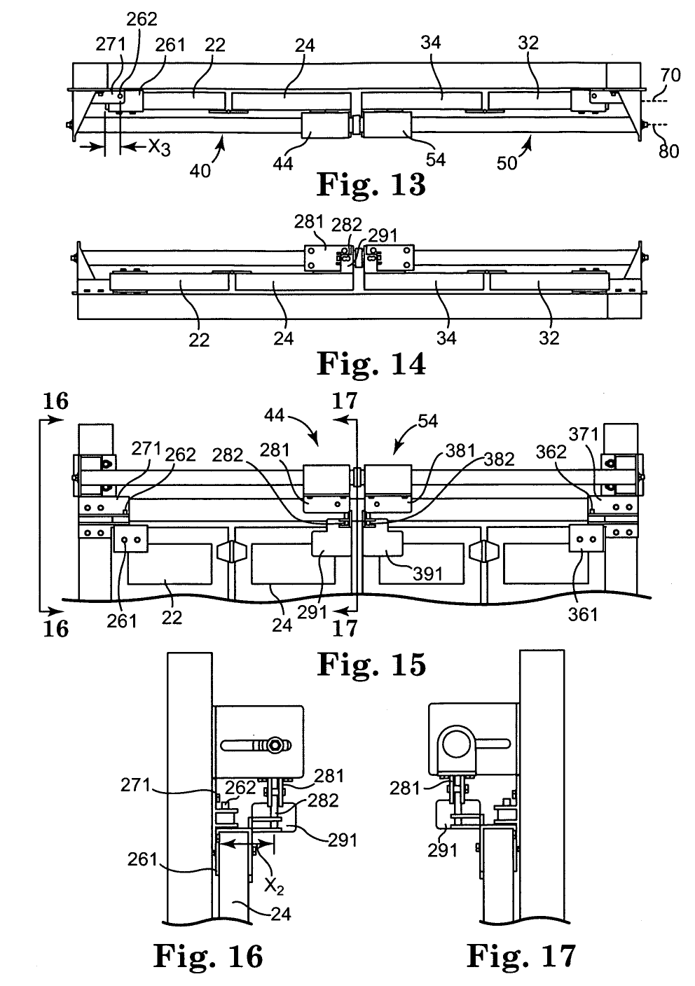

FIG. 13 provides a general top view of symmetrical bi-folding door assemblies 40, 50 employing a magnetically coupled air cylinder as a linear drive. As illustrated in FIG. 13, the door jamb brackets 271, 371 secure the pins (not visible) of the jamb panel brackets 261, 361. The pins ensure that the jamb panels 22, 32 are a correct distance from an interior wall or door jamb 14, 16 (FIG. 1) of the opening 12 and act as pivot points for door operation.

FIG. 14 provides a general view of the bottom of the linear drive mechanisms 40, 50 shown in FIG. 13. The drive pin 282 (one visible) from the linear drive pin bracket 281 is inserted into the drive panel bracket 291 and is aligned with a centerline of the driving assemblies 40, 50 (FIG. 13). The centerline of the driving assemblies 40, 50 is offset from a plane of the door panels 22, 24, 32, 34 in the closed position. This offset enables the door panels to “break” from their coplanar alignment (when in the closed position) when an opening force is applied to the doors 20, 30, and enables a return of the door panels 20, 30 back to their coplanar alignment when the door 20, 30 are closed.

FIG. 15 shows drive pin brackets 281, 381 defining respective pins 282, 382 that slide into respective pin slots of the drive panel brackets 291, 391. The linear drive pin brackets 281, 381 are connected to the carriages 44, 54 that open and close the door assemblies. The drive pin brackets 281, 381 are aligned with the centerline of the linear drive mechanism during operation.

FIG. 16 provides a side view of the left door assembly as viewed from the end of assembly when the door is in the closed position. In one embodiment, X2 is defined to be the distance from a center of the pin 282 on the linear drive pin bracket 281 to the exterior face of the driven panel 24. In one embodiment, X2 is equal to the distance from a center of a pin on the jamb panel bracket 261 to an outside edge of the jamb panel 22, such that the distance X2 of FIG. 16 is equal to distance X3 of FIG. 13.

FIG. 17 provides a side view of the left door assembly as viewed from the center of the opening when the door is in the closed position. As illustrated in FIG. 17, drive pin bracket 281 is perpendicular to a mounting flange of the linear drive pin bracket 291 when the door is in the closed position.

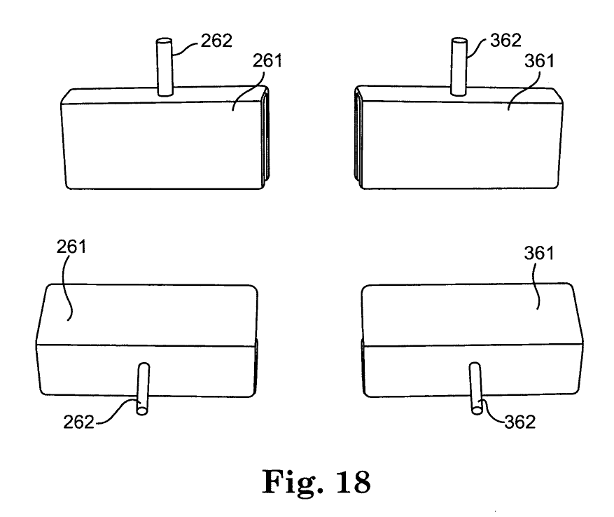

In one embodiment, jamb bracket assemblies 26 and 36 each include respective jamb panel brackets 261 and 361 and respective door jamb brackets 271 and 371. One embodiment of jamb panel brackets 261 and 361 (before mounting holes are formed therein) are shown in FIG. 18 and include respective jamb pins 262 and 362. In one embodiment, jamb panel brackets 261 and 361 are provided on the top and the bottom of respective jamb panels 22 and 32. In this regard, a door jamb bracket 271, for example, is coupled to a first door jamb 14, and a jamb panel bracket 261 is rotatably coupled to the door jamb bracket 271 and coupled to the jamb panel 22 of the bi-fold door 20.

FIG. 18 illustrates jamb panel brackets 261, 361 each defining a respective jamb pin 262, 362 according to one embodiment of the present invention.

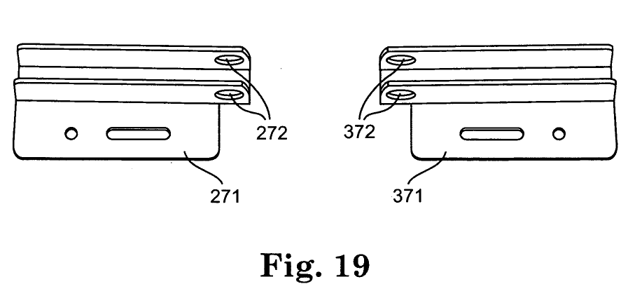

FIG. 19 illustrates door jamb brackets 271 and 371 including respective support holes 272 and 372 according to one embodiment of the present invention for receiving respective jamb pins 262 and 362 extending from respective jamb panel brackets 261 and 361 as shown in FIG. 18. As described above, door jamb brackets 271 and 371 are secured to left door jamb 14 and right door jamb 16, respectively, in assembly the bi-fold door system 10.

FIG. 20 illustrates drive pin brackets 281, 381 each defining a respective drive pin 282, 382 according to one embodiment of the present invention.

FIG. 21 illustrates a pair of drive panel brackets 291, 391 according to one embodiment of the present invention.

With additional reference to FIG. 2, carriages 44 and 54 of linear drive assemblies 40 and 50 are coupled to a respective driven panel 24 and 34 of the bi-fold doors 20 and 30. In this regard, and as best illustrated in FIGS. 20 and 21, in one embodiment drive bracket assemblies 28 and 38 each includes a respective drive pin bracket 281 and 381 and a respective driven panel bracket 291 and 391. Drive pin brackets 281 and 381 are shown in FIG. 20 and define respective drive pins 282 and 382. In one embodiment, drive pin brackets 281 and 381 are attached to respective carriages 44 and 54 of left and right drive assemblies 40 and 50 for movement with carriages 44 and 54 as described above.

With regard to FIG. 21, it is to be understood that driven panel bracket 391 is highly similar to driven panel bracket 291, with the only difference being that driven panel bracket 391 is a “right” hand bracket. In any regard, each driven panel bracket, for example driven panel bracket 291, defines a mounting flange configured to mount to driven panel 24, and a shoulder extending from mounting flange and defining a drive hole 292 (see, for example, FIG. 10) for receiving respective drive pins 282. Driven panel brackets 291 and 391 are secured to driven panels 24 and 34 of left and right door assemblies 20 and 30, respectively, such that movement of drive pins 282 and 382, as controlled by carriages 44 and 54, results in movement of driven panels 24 and 34.

In one embodiment, actuation of left and right drive assemblies 40 and 50 moves left and right door assemblies 20 and 30 between a closed position (see FIG. 9) and an open position (see FIG. 4). In the closed position, as illustrated in FIGS. 13 and 14, left and right door assemblies 20 and 30 are aligned along a door axis 70 that is parallel to and offset from a longitudinal drive axis 80 of the linear drive assemblies 40 and 50. In one embodiment, drive axis 80 of left and right drive assemblies 40 and 50 is offset from door axis 70. As such, jamb bracket assemblies 26 and 36 and drive bracket assemblies 28 and 38 are designed to open and close left and right door assemblies 20 and 30 based on the offset between door axis 70 and drive axis 80.

In one embodiment, jamb panel brackets 261 and 361 are designed such that jamb pins 262 and 362 are offset a distance X1 from respective mounting flanges of jamb panel brackets 261 and 361 (see, for example, FIG. 11). In addition, drive panel brackets 291 and 391 are designed such that drive holes 292 and 392 which receive drive pins 282 and 382 of drive pin brackets 281 and 381 are offset a distance X2 from respective mounting flanges of drive panel brackets 291 and 391 (see, for example, FIG. 16). As such, drive panels 24 and 34 are pivotally secured to the linear drive mechanisms in line with the center line of the drive mechanisms. In one embodiment, when jamb panel brackets 261 and 361 are secured to respective jamb panels 22 and 32, jamb pins 262 and 362 are offset a distance X3 from a jamb edge of respective jamb panels 22 and 32 (see, for example, FIG. 13). In one embodiment, offset distance X3 is equal to offset distance X2.

FIG. 16 illustrates that driven panel brackets 291 and 391 are provides with drive holes 292 and 392 to receive drive pins 282 and 382 of drive pin brackets 281 and 381. In one embodiment, drive holes 292 and 392 are defined in shoulders and are offset a distance X2 from respective mounting flanges of driven panel brackets 291 and 391. As such, driven panels 24 and 34 are pivotally secured to the linear drive mechanisms in line with the centerline of the drive mechanisms. In one embodiment, offset jamb distance X3 is equal to offset distance X2.

Aspects of bi-fold door system 10 are further described below with reference to specific figures.

The bi-fold door system 10 of the present invention employs a linear drive operator and the bracket assemblies as described above to open and close a bi-fold door. During Use, the bracket assemblies 26, 28, 36, 38 include a set of brackets 26, 36 that are secured to the jamb panels 22, 32 on the jamb side of the jamb panels and are coupled through pins to brackets which are fastened to the wall or door jamb at a predetermined distance to create an overlap of the door opening and also to create a predetermined distance between the edge of the jamb panel and the center of the pin. In one embodiment, these brackets are for both the top and bottom of both the left and right jamb panels.

The bracket assemblies also include a set of brackets 28, 38 that are secured to the center or driven panels 24, 34 at an edge of the panels opposite the jamb panel attachment. These brackets form the door drive brackets and are designed with a predetermined offset mounting dimension that creates the force needed to break the driven panels and jamb panels from their coplanar state in the fully closed position when force is applied in a first direction to open the door assemblies. These brackets 28, 38 also allow the driven panels 24, 34 and jamb panels 22, 32 to return to the coplanar state when force is applied in a second, opposite direction to close the door assemblies.

In one embodiment, the door drive brackets 28, 38 are configured so that the distance from the drive pin 282, 382 to the exterior side of the door (X2) is the same as the distance from the center of the pin 262 on the jamb panel bracket 261 to the outside edge of the door (X3).

The linear drive pin bracket 281 is secured to the linear operating mechanism 40 and functions to drive the door to an open position and a closed position. The parallel alignment of this bracket 281 with the drive panel bracket 291 in the open position ensures the locking position of the door.

In one embodiment, the linear drive pin bracket 281 includes a stabilizer bolt 396 (See FIG. 20) that allows for minor adjustments to ensure that the door is held in a locked position perpendicular to the jamb of the opening. This arrangement allows for adjustment to achieve a stop position when the door is fully open and aligns the door in a perpendicular state with the door jamb.

When the above brackets are aligned in a parallel state, the door is locked and the door will not be able to move side to side. Furthermore, when the brackets are aligned, the drive pin receiver bracket extends over the top of the jamb panel when the door is in the open position. This allows the driven panel to rest parallel with the jamb panel in the fully open position.

The bracket assemblies are designed such that during operation of the linear drive mechanisms, the drive pin and the receiver bracket follow the centerline of the linear drive mechanisms as the doors are opened and closed. As such, the distance from the drive mechanism centerline to the center of the pin on the jamb panel bracket remains equal throughout the door travel.

The bracket assemblies, as described above, allow the driving mechanism to break the panels from a mutually coplanar position in the fully closed position and lock the panels in the fully open position, and then return the panels to the coplanar position in the fully closed position. The configuration of the brackets assemblies allow the door to open and close without a breaker arm or other mechanism and without the need for a separate track or guide. As such, the bracket assemblies of the present invention enable a symmetrical bi-folding door system to operate with a linear drive mechanism while eliminating the use of a separate track as a guide. The bracket assemblies of the present invention in conjunction with a linear drive motion, therefore, can be used to operate a bi-folding door as an automated door system while lowering cost and minimizing clearance space above, to the side, and/or inside of the jambs of the opening.

FIG. 22 illustrates bi-fold door system 10 including a first break cylinder 400 and a second break cylinder 402 according to one embodiment of the present invention. First break cylinder 400 includes an actuator 404 and a rod 406 extending from actuator 404.

In one embodiment, actuator 404 is mounted to a wall adjacent to left door jamb 14, and rod 406 extends to and is coupled to a plate 407 that is coupled to jamb panel bracket 261. Second break cylinder 402 includes an actuator 410 and a rod 412 extending from actuator 410. In one embodiment, actuator 410 is mounted to a wall adjacent to right door jamb 16, and rod 406 extends to and is coupled to a plate 413 that is coupled to jamb panel bracket 361. In one embodiment, plate 407 is coupled to be co-extensive with jamb panel bracket 261, and plate 413 is coupled to be co-extensive with jamb panel bracket 361. In this regard, in one embodiment, plates 407, 413 are angle brackets extending from a respective one of jamb panel brackets 261, 361 (i.e., out of the plane of the paper in FIG. 22) and are configured to receive a respective one of rods 406, 412.

To this end, actuation of actuator 404, for example, displaces rod 406 that imparts a force to jamb panel bracket 261, thus “breaking” a planar orientation of jamb panel 22 relative to driven panel 24. In one embodiment, each of first break cylinder 400 and a second break cylinder 402 is pneumatically coupled to the cylindrical housings of linear drive assemblies 40, 50 (FIG. 1), such that activation of linear drive assemblies 40, 50 is preceded by activation of break cylinders 400, 402. In this regard, break cylinders 400, 402 are pneumatic break cylinders that are fluidly coupled with the cylindrical housing of the linear drive assembly 40, 50 and coupled between a respective door jamb 14, 16 and a jamb panel 22, 32 of the bi-fold door.

In one embodiment, linear drive assemblies 40, 50 each include a stop bolt and a spring-biased rod provided at an end of respective linear actuators 42, 52 adjacent to respective door jamb brackets 271, 371 such that respective carriages 44, 54 contact the respective spring-biased rod and stop bolt when the bi-fold door is in the open position. As such, the stop bolt limits the travel of respective carriages 44, 54 when the bi-fold door is moved to the open position and the spring-biased rod provides a spring bias against respective carriages 44, 54 to assist in returning the bi-fold door to the closed position.

FIG. 23 is a simplified schematic of an air line routing path 420 as coupled between a linear drive assemblies 40, 50 and a pair of break cylinders 400, 402 according to one embodiment of the present invention. Air line routing path 420 includes an air source 422, tubing 423, and a plurality of flow control valves/regulators 424 and a plurality of T-fittings 426 coupled to the tubing 423. In one embodiment, air source 422 is a pneumatic system that is electrically energized and configured to actuate linear drive assembles 40, 50 and break cylinders 400, 402. In a preferred embodiment, break cylinders 400, 402 are actuated just prior to activation of linear drive assembles 40, 50, such that the bi-fold door panels are shunted from a planar orientation to a non-planar orientation, thus initiating a more efficient opening of the bi-fold doors.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

1. A drive assembly for use with a bi-fold door, the drive assembly comprising:
a cylindrical housing;
a shuttle disposed within the cylindrical housing; and
a carriage supported about the cylindrical housing and operatively coupled to the shuttle;
wherein the carriage is coupled to the bi-fold door, and wherein movement of the shuttle within the cylindrical housing moves the carriage along the cylindrical housing and moves the bi-fold door between open and closed positions.

2. The drive assembly of claim 1, wherein the shuttle is pneumatically activated and the carriage is magnetically coupled to the shuttle.

3. The drive assembly of claim 1, further comprising:
a second shuttle disposed within the cylindrical housing; and
a second carriage supported about the cylindrical housing and operatively coupled to the second shuttle;
wherein the second carriage is coupled to a second bi-fold door, and wherein movement of the second shuttle within the cylindrical housing moves the second carriage along the cylindrical housing and moves the second bi-fold door between open and closed positions.

4. The drive assembly of claim 1, wherein the bi-fold door defines a bi-fold door plane when the bi-fold door is in the closed position, and wherein a linear axis of the drive assembly is substantially parallel to the bi-fold door plane.

5. The drive assembly of claim 4, wherein the linear axis of the drive assembly is offset from the bi-fold door plane.

6. The drive assembly of claim 1, further comprising:
a drive pin bracket coupled to the carriage and including a drive pin; and
a drive panel bracket coupled to a driven panel of the bi-fold door and including a mounting flange and a shoulder extending from the mounting flange, the shoulder defining a drive hole configured to receive the drive pin of the drive pin bracket.

7. The drive assembly of claim 6, wherein the drive hole of the drive panel bracket is offset a first distance from the mounting flange of the drive panel bracket.

8. The drive assembly of claim 7, wherein the driven panel is pivotally secured to the drive assembly and offset from a center line of the drive assembly by a distance equal to the first distance.

9. The drive assembly of claim 6, further comprising:
a stabilizer bolt threadingly coupled to the drive pin bracket orthogonal to the drive pin.

10. The drive assembly of claim 1, wherein the bi-fold door includes a driven panel and a jamb panel hinged to the driven panel, wherein the carriage of the drive assembly is coupled to the driven panel of the bi-fold door and a break rod is coupled to the jamb panel of the bi-fold door.

11. A bi-fold door system comprising:
a bi-fold door including a driven panel and a jamb panel supported in an opening;
a linear drive assembly supported about the opening and including a shuttle and a carriage operatively coupled to the shuttle;
a jamb bracket assembly coupled to a door jamb of the opening and the jamb panel of the bi-fold door; and
a drive bracket assembly coupled to the driven panel of the bi-fold door and coupled to the carriage of the linear drive assembly;
wherein movement of the shuttle along a linear axis moves the carriage along the linear axis and moves the bi-fold door between open and closed positions.

12. The bi-fold door system of claim 11, wherein the jamb bracket assembly includes:
a jamb bracket coupled to the door jamb of the opening; and
a jamb panel bracket rotatably coupled to the jamb bracket and coupled to the jamb panel of the bi-fold door.

13. The bi-fold door system of claim 12, wherein the jamb panel bracket includes a jamb pin and the jamb bracket defines a bore configured to receive the jamb pin.

14. The bi-fold door system of claim 13, wherein the jamb pin is offset from a mounting flange of the jamb panel bracket.

15. The bi-fold door system of claim 13, wherein the jamb pin is offset a first distance from an edge of the jamb panel of the bi-fold door.

16. The bi-fold door system of claim 15, wherein the drive bracket assembly includes:
a drive pin bracket coupled to the carriage and including a drive pin; and
a drive panel bracket including a mounting flange coupled to the driven panel of the bi-fold door and a shoulder extending from the mounting flange, the shoulder defining a drive hole configured to receive the drive pin of the drive pin bracket;
wherein the drive pin is offset a second distance from the mounting flange of the drive panel bracket, wherein the second distance and the first distance are substantially equal.

17. The bi-fold door system of claim 11, further comprising:
a break cylinder supported about the opening and extending to the jamb panel.

18. The bi-fold door system of claim 11, wherein the linear drive assembly operates along a linear axis oriented substantially parallel to and offset from a plane of the bi-fold door defined when the bi-fold door is in the closed position.

19. The bi-fold door system of claim 11, wherein the jamb panel and the driven panel are coplanar when the bi-fold door is in the closed position, and the jamb panel and the driven panel are substantially perpendicular to the linear drive assembly when the bi-fold door is in the open position.

20. The bi-fold door system of claim 11, wherein the shuttle of the linear drive assembly is pneumatically activated and the carriage of the linear drive assembly is magnetically coupled to the shuttle.

21. A method of opening and closing a bi-fold door supported in an opening, the method comprising:
supporting a linear drive assembly about the opening and coupling a carriage of the linear drive assembly to a driven panel of the bi-fold door; and
moving the carriage along a linear axis of the linear drive assembly, including moving the bi-fold door between open and closed positions.

22. The method of claim 21, wherein coupling the carriage of the linear drive assembly to the driven panel of the bi-fold door includes extending a drive bracket assembly between the carriage and the driven panel, wherein the drive bracket assembly includes:
a drive pin bracket coupled to the carriage and including a drive pin; and
a drive panel bracket including a mounting flange coupled to the driven panel of the bi-fold door and a shoulder extending from the mounting flange, the shoulder defining a drive hole configured to receive the drive pin, wherein the drive pin is offset a first distance from the mounting flange of the drive panel bracket.

23. The method of claim 21, wherein moving the carriage includes pneumatically activating the linear drive assembly.

24. The method of claim 22, further comprising:
supporting a jamb panel of the bi-fold door within the opening, wherein moving the bi-fold door includes rotating the jamb panel of the bi-fold door about an axis offset a second distance from an edge of the jamb panel, wherein the first distance and the second distance are substantially equal.

25. The method of claim 21, further comprising:
activating a break cylinder coupled to a jamb panel of the bi-fold door to initiate moving the bi-fold door.

26. The method of claim 21, wherein moving the carriage includes opening the bi-fold door by displacing coplanar hinged panels of the bi-fold door into a substantially parallel and non-coplanar arrangement.

27. The method of claim 21, wherein moving the carriage includes closing the bi-fold door by displacing substantially parallel and non-coplanar hinged panels of the bi-fold door into a coplanar arrangement.

28. A bi-fold door system comprising:
a driven panel and a jamb panel supported within an opening;
a linear drive assembly supported about the opening and including a carriage oriented along a linear axis;
means for coupling the carriage to the driven panel of the bi-fold door, wherein a face of the driven panel is offset a first distance from the linear axis; and
means for rotating the jamb panel of the bi-fold door about an axis offset a second distance from an edge of the jamb panel, wherein the first distance and the second distance are substantially equal.

29. The bi-fold door system of claim 28, wherein means for coupling the carriage to the driven panel of the bi-fold door includes a drive bracket assembly including:
a drive pin bracket coupled to the carriage and including a drive pin; and
a drive panel bracket including a mounting flange coupled to the driven panel and a shoulder extending from the mounting flange by at least the first distance, the shoulder defining a drive hole configured to receive the drive pin.

30. The bi-fold door system of claim 28, wherein means for rotating the jamb panel of the bi-fold door includes a jamb bracket assembly including:
a jamb bracket supported adjacent the opening; and
a jamb panel bracket rotatably coupled to the jamb bracket and coupled to the jamb panel of the bi-fold door, wherein the jamb panel bracket includes a jamb pin and the jamb bracket defines a bore configured to receive the jamb pin, wherein the jamb pin is offset from a mounting flange of the jamb panel bracket.
